(19) United States
(12) Patent Application Publication
(10) Pub. No.: US 2012/0255350 A1
(43) Pub. Date: Oct. 11, 2012

(54) APPARATUSES AND METHODS FOR VISUALIZING AIR FLOW AROUND VEHICLES

(75) Inventor: Anthony A. Nobles, Fountain Valley, CA (US)

(73) Assignee: TECHNOS, INC., Fountain Valley, CA (US)

(21) Appl. No.: 13/441,157

(22) Filed: Apr. 6, 2012

Related U.S. Application Data
(60) Provisional application No. 61/473,707, filed on Apr. 8, 2011.

(51) Int. Cl. G01M 9/00

(52) U.S. Cl. 73/147

(57) ABSTRACT

Described herein are embodiments of an apparatus for visualizing air flow around a vehicle. Such embodiments can comprise one or more gas emitters supportable by a vehicle, one or more imaging devices having a field of view of at least a portion of the gas flowing over the vehicle, and a light source for irradiating at least a portion of the field of view of the one or more imaging devices. Some embodiments of the apparatus can have a signal processor configured to generate an image based on an input from the imager. The apparatus can be configured such that the gas is not detectable to the naked eye so as to not obstruct a vehicle operator's field of vision. The apparatus can be configured to produce an image of the flow of the gas over the one or more surfaces of the vehicle when in an operational state.

### PRIORITY INFORMATION AND INCORPORATION BY REFERENCE

This application claims priority benefit of U.S. Provisional Application 61/473,707 (titled “APPARATUSES AND METHODS FOR VISUALIZING AIR FLOW AROUND VEHICLES”), filed Apr. 8, 2011, which application is hereby incorporated by reference in its entirety as if fully set forth herein. The benefit of priority is claimed under the appropriate legal basis including, without limitation, under 35 U.S.C. §119(e). Additionally, U.S. Pat. No. 4,555,627, filed on Apr. 5, 1983 (titled “BACKSCATTER ABSORPTION GAS IMAGING SYSTEM”) is hereby incorporated by reference in its entirety as if fully set forth herein.

### BACKGROUND OF THE DISCLOSURE

1. Field of the Disclosure

Some arrangements of the present disclosure relate to apparatuses and methods for visualizing air flow around vehicles, more particularly, to apparatuses and methods for real-time visualization of air flow patterns around moving vehicles.

2. Background of the Disclosure

For racecars or other vehicles, the effect of the body structures or other structures, such as wings, winglets, airfoils, exhaust pipes, decals, or any other objects or surfaces of the racecar or vehicle, on the aerodynamics and performance of the racecar can be significant. Some embodiments disclosed herein can be used to measure the effect of such body structures or objects to determine the effect of such objects on the vehicle's performance.

### SUMMARY OF THE DISCLOSURE

Accordingly, some embodiments described herein are directed to methods and apparatuses for visualizing, detecting, and/or analyzing airflow over and/or around a vehicle, for example, without limitation, a moving vehicle or a vehicle in a wind tunnel. The vehicle can be, without limitation, an automobile including a racecar, truck, and otherwise, a bicycle, a motorcycle, a boat, an airplane, or any other transportation to apparatus (collectively referred to herein as and illustrated as a vehicle, which is meant to collectively or independently represent any of the foregoing vehicles). For racecars or other vehicles, the effect of the body structures or other structures, such as wings, winglets, airfoils, exhaust pipes, decals, or any other objects or surfaces of the racecar or vehicle, on the aerodynamics and performance of the racecar can be significant. Accordingly, any changes to such objects or surfaces can also be significant, and can change based on air an environmental conditions such as air temperature, barometric pressure, wind, or other weather condition, track conditions, and the effects of other vehicles, to name a few.

The embodiments of the present disclosure can be used to ascertain, analyze, and understand the effects of making changes to a vehicle's configuration, thereby educating the vehicle driver and support team as to the effect of such changes. For example, based on visualization or detection data obtained by the embodiments of the visualization system disclosed herein during operation of the vehicle, modifications can be made to the vehicle to improve the aerodynamics of the vehicle (which may include increasing downdraft). Such changes can include, without limitation, changing the position or orientation of wings, winglets, or other objects, adding or removing winglets or other objects, or making other adjustments to the vehicle.

In some instances, such changes can be made during a routine pit stop or at any intervals during the course of a race or during practice. Because a wind tunnel simulation may not precisely simulate the actual conditions on a race or practice course or during the operation of the vehicle, and because no other methods are known for doing so, the benefits of gathering airflow data during the actual operation of the vehicle afforded by the embodiments of the airflow imaging systems of the present disclosure are tremendous.

In some embodiments, some or all of the components comprising the apparatus for detecting airflow around a moving vehicle can be mounted or attached to, supported by, or otherwise integrated on, into, or under the vehicle. In other embodiments, some or all of the components comprising the apparatus for detecting airflow around a moving vehicle can be mounted or attached to, supported by, or otherwise integrated with fixed or moveable components positioned adjacent to the vehicle.

As will be described, the apparatus for detecting airflow can be used for real-time data gathering for racecars or for other vehicles to enable a driver, pit crew, or other a person or even a computer to analyze the air/gas flow patterns around the vehicle to determine the effects of drag, drafting, down drafting, lift, etc. As such, the apparatus can be configured to provide real-time feedback to the driver of the vehicle that may affect the decisions the driver makes during a race. Additionally, the information gathered by the embodiments of the apparatus disclosed herein can be recorded for future reference.

Some embodiments disclosed herein relate to an apparatus for visualizing air flow around a vehicle. Such embodiments can comprise one or more gas emitters supportable by a vehicle, one or more imaging devices having a field of view of at least a portion of the gas flowing over the vehicle, and a light source for irradiating at least a portion of the field of view of the one or more imaging devices. Some embodiments of the apparatus can have a signal processor configured to generate an image based on an input from the imager. The apparatus can be configured such that the gas is not detectable to the naked eye so as to not obstruct a vehicle operator's field of vision. The apparatus can be configured to produce an image of the flow of the gas over the one or more surfaces of the vehicle when in an operational state.

Some embodiments are directed to an apparatus for visualizing air flow around a vehicle, comprising one or more gas emitters supportable by a vehicle, each configured to emit a gas that can flow over one or more surfaces of the vehicle as ambient air passes over the vehicle. The apparatus can also have one or more imaging devices each having a field of view of at least a portion of the gas flowing over the vehicle, an ultrasound or radar signal source for transmitting a signal to at least a portion of the field of view of each or all of the one or more imaging devices, and/or a signal processor configured to generate an image based on an input from the imager. In some embodiments, the apparatus can be configured such that the gas is not detectable to the naked eye so as to not obstruct a vehicle operator's field of vision. The ultrasound or radar signal source can be configured to emit a signal at a wavelength that will be reflected by the gas. Further, the apparatus can be configured to produce an image of the flow of the gas over the one or more surfaces of the vehicle when in an operational state.

Some embodiments or arrangements described herein are directed to a method of visualizing air flow around a vehicle, comprising emitting a gas from one or more gas emitters into a flow of air moving past a vehicle, irradiating a field of view of one or more imaging devices with a light source at a wavelength that will be absorbed by the gas, the field of view being directed to at least a portion of the gas flowing over the vehicle, gathering an image of the field of view with the one or more imaging devices, and generating an image on a video screen of the flow of gas around the vehicle based on a signal output from the imager. The gas can be invisible or nearly invisible to the naked eye.

### BRIEF DESCRIPTION OF THE DRAWINGS

These and other features, aspects and advantages of the present disclosure will now be described in connection with non-exclusive embodiments, in reference to the accompanying drawings. The illustrated embodiments, however, are merely examples and are not intended to be limiting. The following are brief descriptions of the drawings, which may not be drawn to scale.

FIG. 1 is a side view of a racecar having an embodiment of an apparatus for visualizing, detecting, analyzing, and/or recording airflow over and/or around the vehicle.

FIG. 2 is an isometric view of a racecar having an embodiment of an apparatus for visualizing, detecting, analyzing, and/or recording airflow over and/or around the vehicle.

FIG. 3 is a front view of a racecar having an embodiment of an apparatus for visualizing, detecting, analyzing, and/or recording airflow over and/or around the vehicle.

FIG. 4 is a rear view of a racecar having an embodiment of an apparatus for visualizing, detecting, analyzing, and/or recording airflow over and/or around the vehicle.

FIG. 5 is a bottom view of a racecar having an embodiment of an apparatus for visualizing, detecting, analyzing, and/or recording airflow over and/or around the vehicle.

### DETAILED DESCRIPTION OF THE PREFERRED EMBODIMENTS

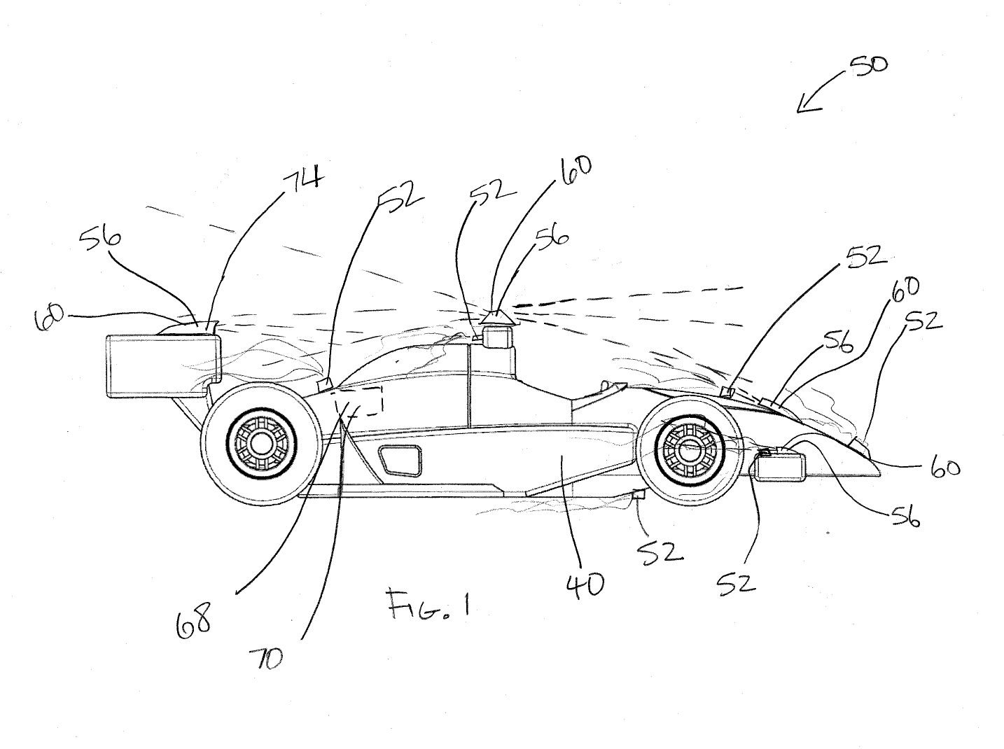

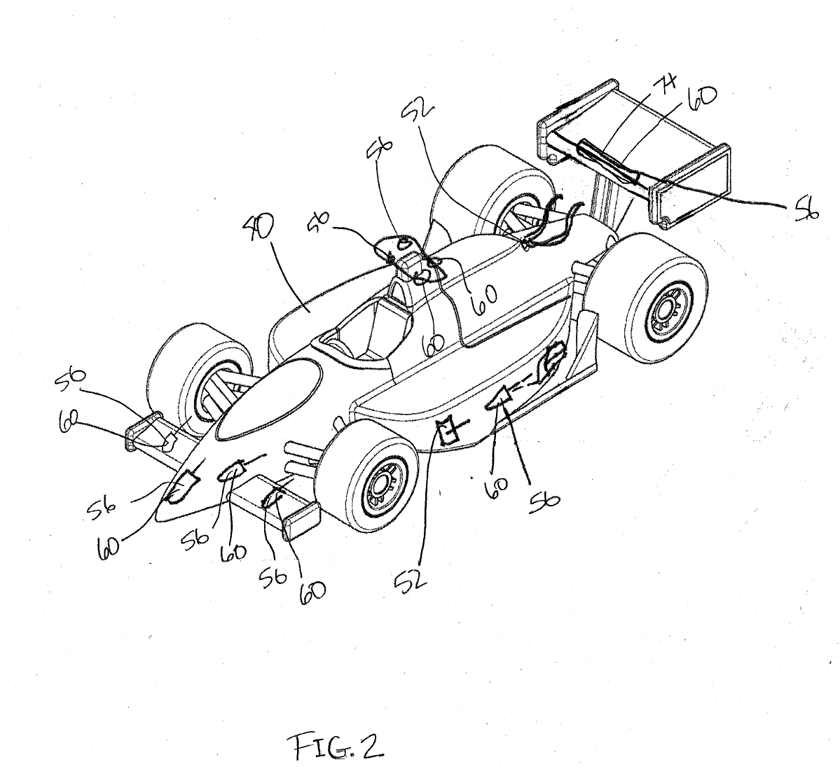

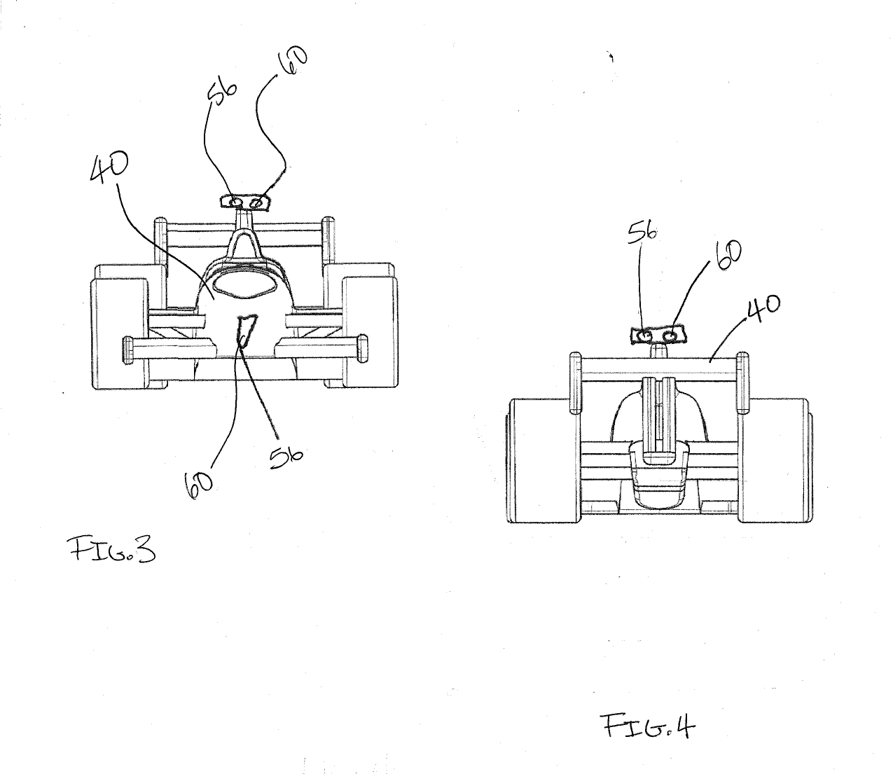

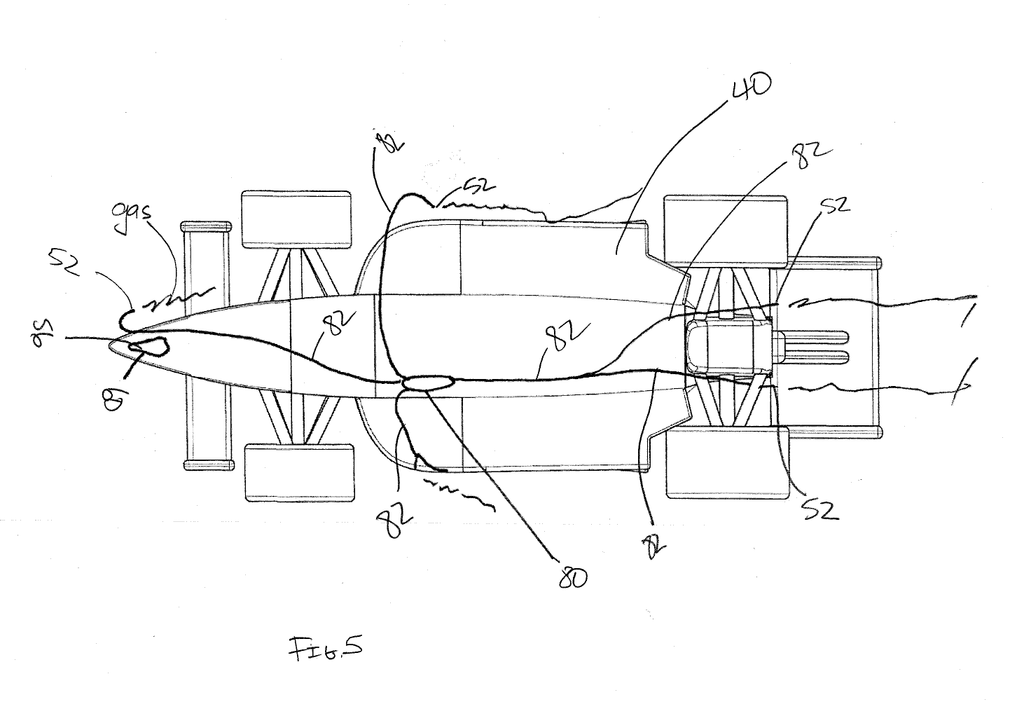

FIGS. 1-5 are side, isometric, front, back, and bottom views, respectively, of a racecar 40 having an embodiment of an apparatus 50 for visualizing, detecting, analyzing, and/or recording airflow over and/or around the vehicle. In some embodiments, as in the embodiment illustrated in FIG. 1, the gas/air flow visualization system 50 can comprise one or more gas emitters 52, one or more laser emitter or other suitable light source or emitter 56 (also referred to herein as light emitter), one or more imaging systems such as imaging optics, detection arrays or cameras and/or other suitable system or systems for capturing a plurality or sequence of images, such as and collectively referred to as a video imaging system 60, a signal processor 68, a control system 70, and/or a receiver/transmitter system 74. One or more of the components can be positioned on a vehicle, such as a race car, in any of a variety of different positions. This includes, without limitation, the positions shown in the accompanying figures or any combination of such positions.

In any of the embodiments disclosed herein, including the embodiments illustrated or described with reference to FIGS. 1-4, any of the foregoing components of the apparatus 50 can be positioned in the same housing or adjacent housings. For example and without limitation, in some embodiments, the light emitter, gas emitter, and/or video imaging system can be positioned in the same housing or adjacent housings. In some embodiments, the light emitter, gas emitter, the video imaging system and/or receiver/transmitter system can be positioned in the same housing or adjacent housings. In some embodiments, as in the embodiment illustrated in FIG. 1, the signal processor 68 and control system 70 can be positioned within the vehicle's exterior.

In any of the embodiments described herein or in the figures, the gas emitters can be in any suitable location, including without limitation the locations depicted in FIG. 1 or described with reference to FIG. 1 or any of the other figures. Similarly, in any of the embodiments described herein or in the figures, one or more light emitters can be positioned in any suitable location, including without limitation the locations depicted in FIG. 1 or described with reference to FIG. 1 or any of the other figures.

One or more of the components, features, or details of the visualization system or apparatus disclosed herein can be the same as or similar to one or more of the components, features, or details of the backscatter absorption gas imaging system embodiments disclosed in U.S. Pat. No. 4,555,627, the entirety of which is hereby incorporated by reference. In some embodiments, without limitation, the laser emitter, the video imaging system, and/or the signal processor can have any of the same or similar components, features, and/or details as the embodiments disclosed in U.S. Pat. No. 4,555,627. Further, in some embodiments, one or more of the components, features, or details of the visualization system or apparatus disclosed herein can be the same as or similar to one or more of the components, features, or details of the GasVue TG30 sold by ETG Risorse E Tecnologia (http://www.etgrisorse.com/prodotti_en.php?id=42).

In some embodiments, one or more gas emitters 52 (for example, without limitation, four, six or more gas emitters) can be positioned on a forward end portion of the vehicle and be configured to emit an innocuous marker gas that is detectable by the imaging system, yet invisible to the naked eye so as to not obstruct the vehicle operator or others. For example, for vehicles that are appropriately configured, one or more gas emitters 52 can be positioned under the vehicle's exterior body and configured such that one or more outlet ports controllably eject the marker gas at the forward end of the racecar, such as adjacent to the racecar's hood, front bumper, or front end. In this arrangement, the gas emitter can be flush with the outside surface of the vehicle such that the aerodynamics of the vehicle will be unaffected or substantially unaffected by the gas emitter. In any of the embodiments disclosed herein, any of the components can be mounted so as to be flush or approximately flush with an outside surface of the vehicle.

In some embodiments, one port could be located adjacent to each of the two corners at the front of the car, and one or more additional ports can be located near the middle portion of the front of the vehicle. Additionally, ports for the gas emitter can be located on one or more sides of the vehicle, adjacent to the vehicle's windscreen, on a fore or aft portion of the vehicle's roof, or in any other suitable location. In some embodiments, the imaging components and/or light source 56 (which can have a laser) can be positioned adjacent one or more of the gas emitters or ports at the front end or otherwise of the vehicle. Additionally or alternatively, one or more gas emitters and/or other components of the visualization system can be positioned near a rearward end of the vehicle or otherwise be positioned and configured to analyze the effects of airflow on trailing vehicles.

In some embodiments, as illustrated in FIG. 5, the apparatus 50 can have a tank 80 connected to a plurality of gas emitters or ports 52 using one or more conduits 82, which can be tubes. The tank 80 can be positioned inside of, flush to, or otherwise relative to the exterior of the vehicle's surface so as to not affect the aerodynamics of the vehicle. In some embodiments, the tank 80 can be positioned underneath the vehicle or on the vehicle's chassis.

The gas can be any gas that is detectable by the apparatus, including without limitation, sulfur hexafluoride, Freon-11, Freon-12, Freon-13, vinyl chloride, benzene, methanol, or any other gases that have favorable absorption characteristics (or reflective characteristics for embodiments disclosed herein using reflective or front-scatter technology) and are less prevalent in ambient air. Other gases, preferably inert, can also be used with this system. Additionally, in some embodiments, two or more gases can be combined or mixed either prior to operating the visualization system or real-time during operation of the visualization system by adjusting the flow rate of separate canisters flowing to the gas emitters. For example, a first gas can be contained within a first gas canister and a second gas can be contained within a second gas canister. Round, tubular or flat conduit or tubing (for example, without limitation, ⅛ in diameter round tubing) can be used to channel the gas from the canisters to the one or more ports positioned about the vehicle, wherein the conduit is connected to each of the two or more canisters. The size of the canister or canisters can be chosen based on the operating conditions and operating time of the visualization system. The canisters can be supported within a position in the vehicle that is easily accessible to enable refilling and/or replacement of the gas cylinder with the same or other suitable gas.

One or more controllable valves can be used to independently control the flow rate of the gas coming from each of the two or more gas canisters and/or gas emitters 52. In some embodiments, the gas emitters can be configured to controllably emit one or more different types of gas or mixtures of gas, depending on the speed of the vehicle, lighting conditions, and other conditions surrounding the vehicle. The control system can be used to control the gas mixtures, flow rate of the one or more gases. Additionally, one or more of the valves, flow rates, and/or gas mixtures can be manually adjustable, while others of the valves, flow rates, and/or gas mixtures can be computer controlled and adjusted or remotely controlled and adjusted.

The speed of the vehicle or air velocity relative to the vehicle, weather conditions, detectability of the marker gas, ambient lighting or reflectivity in the field of view, the intensity of the laser or light source, and/or sensitivity of the visualization components can all affect the visualization of the flow patterns of the gas around the vehicle. As such, the number of gas emitters, type of gas emitted, and/or the flow rate of the gas emitted by the one or more gas emitters can be modified or adjustable during or apart from the operation of the apparatus to improve the visualization of the gas flowing around the vehicle. Additionally, the apparatus can be configured to permit adjustability of the other components, including without limitation the laser or light source, imager, or monitor, to improve the clarity of the images gathered by the apparatus.

In some embodiments, one or more gas emitters containing one or more different types of gas can be used depending on the speed of the vehicle or other air conditions during the operation of the apparatus. For example, the apparatus can be configured so as to emit one type of gas in a first vehicle speed range or weather condition, and another type of gas being a second vehicle speed range or weather condition. Again, the gas or gases to be used can be invisible to the operator of the vehicle so as to not obscure the operator's vision.

In some arrangements, the visualization or imaging apparatus can have an infrared imager that images or detects some or all of the flow of the gas emitted by the gas emitters around the vehicle within the field of view of the imager. The apparatus can be configured such that all or substantially all or a portion of the field of view of the one or more optical components of the imaging system (also referred to herein as an imager) can be radiated by a laser light source, one or more lamps, light emitting diodes, fluorescent devices, or other light source at a wavelength that is absorbed by the gas emitted by the emitters. In this configuration, the field of view of the imaging system will be illuminated by the laser or other light source. Suitable lasers may include, without limitation, solid state lasers, laser diodes, fiber lasers, gas lasers, semiconductor lasers, or other similar or suitable types of lasers or laser systems. Additionally, delivery systems for delivery of light into the field of view can have one or more lenses, fiber optics, mirrors, or other optics.

In some embodiments, when the gas emitted by the emitters is introduced into the field of view of the imaging system, the gas will appear darker than the surrounding portion of the field of view due to the absorption of the laser or other light by the gas, thereby permitting the visualization of the gas flow. Additionally, in some embodiments, the visualization or imaging apparatus can have an imager that images or detects some or all of the flow of the gas emitted by the gas emitters around the vehicle within the field of view of the imager by detecting light reflected or radiated by the emitted gas in response to radiating the field of view with a fluorescent or other suitable light source.

In some embodiments, a plurality of laser or other light sources can be used to provide better illumination or irradiation of the field of view. Additionally, one of more of the laser or light sources can be movable, being configured to quickly move or scan across or up and down over the field of view, to provide a complete image of the entire or a portion or substantial portion of the field of view.

In some arrangements, the visualization apparatus can have an imager (which can be an infrared imager) that is configured to gather the reflected and/or radiated light in the field of view of the relevant portion of the air/gas flowing around the vehicle upon irradiation of the field of view by the laser or other suitable light source. The components of the imaging system can be positioned at one or more positions on the vehicle to provide the image of the air/gas flow that will provide the clearer image of the gas/air flow pattern. For example, in some arrangements, one or more optical components can be positioned at the rear of the vehicle facing generally forward along the top and/or sides of the vehicle (i.e., facing into the flow of air/gas). Additionally or alternatively, one or more optical components can be positioned on the sides of the vehicle at one or more locations along the length of the vehicle so as to be at an angle relative to the flow of air/gas or oriented perpendicular to the flow of air/gas. Mirrors, lenses or other detection optics may be used.

Additionally, an ultrasound, radar system, or other suitable signal system can be substituted in place of or used in addition to any of the laser or light source components in any of the embodiments disclosed herein to form new embodiments. In such embodiments, the suitable gas would be one that can reflect the signals from such ultrasound, radar, or other systems to a higher degree than the ambient air flowing over the vehicle. Ultra-high frequency (UHF), very high frequency (VHF), or other suitable radar sources can be used.

The apparatus can further have a signal processor in communication with the imager to generate an imaging signal such as a signal that can be viewed on a monitor or plurality of monitors. As mentioned, one or more monitors can be positioned within the vehicle so as to be viewable by the driver. Additionally or alternatively, one or more monitors can be positioned outside the vehicle, usable by a pit crew or other persons. Data image or video can be recorded. The apparatus 50 can also have a recording device positioned on or inside an exterior surface of the vehicle.

In some embodiments, the apparatus can be linked to one or more indicators within the vehicle to communicate to the driver of the vehicle the favorability of the airflow conditions around the vehicle, so that the driver can merely glance at the one or more indicators to determine the state of the airflow surrounding the vehicle. For example, an indicator light could have a plurality of different colors, each color corresponding to a different air flow condition outside the vehicle. Similarly, a plurality of indicator lights could be linked to the apparatus to indicate, on a scale basis, the favorability of the conditions outside the vehicle.

Further, a receiver/transmitter (e.g., wireless communication devices, etc.) can be positioned on or in the vehicle to send and receive operational signals to and from the gas/air flow monitoring system, and to transmit visual images (or data related thereto) from the gas/air flow monitoring system for other users. For example, a pit crew could have monitors configured to show real-time air/gas flow patterns detected by the gas/air flow monitoring system so as to improve their ability to instruct the vehicle driver regarding the flow patterns.

A control system can be used to control the various components, features, or operations of the various components comprising the apparatus. For example, the control system can be linked to the one or more gas emitters to activate the gas emitters and to control the level of gas emitted and flow rate, etc. from the emitters. Further, the control system can be configured to automatically adjust the amount of gas emitted based on the speed of the vehicle, to adjust the sensitivity of the imager, or the positioning or intensity of the laser or light source. The control system can also be used to control the optical components of the imaging system to activate and/or adjust the field of view and/or angle of such components, to pan, zoom, or scan the field of view, etc. Some or all aspects of the control system may be accessible by the vehicle operator and/or wireles sly by, for example, a pit crew or otherwise. The control system can be pre-programmed to adjust the system in accordance with the vehicle speed, light conditions, environmental conditions surrounding the vehicle, etc. In some embodiments, the system can be configured to scan illumination across the field of view using. In some embodiments, minors can be used for this.

Additionally, in some arrangements, the gas/air flow monitoring apparatus can have a recording system to record the visual images that are collected for later viewing and/or analysis. A power source for the apparatus can be supported by the vehicle to provide the necessary power for the laser or light source, the control system, the gas emitters, the imager, and/or any other components of the apparatus.

Additionally, the gas/air flow monitoring system can be used in a wind tunnel such that the gas emitters and imaging system can be located external to the vehicle. In a further variation, the gas emitters can be located on the subject vehicle or even on a rearward portion of a leading vehicle, while other portions of the gas/air flow monitoring system, such as the imaging system, can be located external to the vehicle. For example, the imaging system can be located at various points along the race track or practice track, or even on a separate vehicle or moveable instrument to detect the air/gas flow during a race (for example, a on teammate's vehicle), or during simulated experimentation or practice runs.

Although the inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of the inventions, will be readily apparent to those of skill in the art based upon this disclosure. Other configurations of any of the components disclosed herein or any other components or combination of components known in the art or to one of ordinary skill in the art can be used with any of the other components disclosed herein to form additional embodiments that may not have been explicitly described herein. All such embodiments form part of the present disclosure.

It can be also contemplated that various combinations or subcombinations of the specific features and aspects of the embodiments may be made and still fall within the scope of the inventions. For example, in some embodiments, the features, configurations, or other details disclosed or incorporated by reference herein with respect to some of the embodiments are combinable with other features, configurations, or details disclosed herein with respect to other embodiments to form new embodiments not explicitly disclosed herein. All of such embodiments having combinations of features and configurations are contemplated as being part of this disclosure. Additionally, unless otherwise stated, no features or details of any of the stent or connector embodiments disclosed herein are meant to be required or essential to any of the embodiments disclosed herein, unless explicitly described herein as being required or essential.

Accordingly, it should be understood that various features and aspects of the disclosed embodiments can be combined with or substituted for one another in order to form varying modes of the disclosed inventions. Thus, it can be intended that the scope of the present inventions herein disclosed should not be limited by the particular disclosed embodiments described above.

What is claimed is:

1. An apparatus for visualizing air flow around a vehicle, comprising:
one or more gas emitters supportable by a vehicle, each configured to emit a gas that can flow over one or more surfaces of the vehicle as ambient air passes over the vehicle;
one or more imaging devices each having a field of view of at least a portion of the gas flowing over the vehicle;
a light source for irradiating at least a portion of the field of view of each or all of the one or more imaging devices;
a signal processor configured to generate an image based on an input from the imager;
wherein:
the gas is not detectable to the naked eye so as to not obstruct a vehicle operator's field of vision;
the light source is configured to emit light at a wavelength that will be absorbed by the gas; and
the apparatus is configured to produce an image of the flow of the gas over the one or more surfaces of the vehicle when in an operational state.

2. The apparatus of claim 1, further comprising a transmitter for transmitting a visual signal to a remote monitor.

3. The apparatus of claim 1, comprising five or more gas emitters positioned at various locations about the vehicle.

4. The apparatus of claim 1, wherein the light source is a laser.

5. A vehicle comprising the apparatus of claim 1, wherein the vehicle is a bicycle, motorcycle, racecar, boat, or airplane.

6. The apparatus of claim 1, wherein the signal processor is configured to generate an image based on an input from the imager.

7. The apparatus of claim 1, wherein each of the one or more imaging devices is responsive to backscattered light radiation and/or to background infrared radiation from within the field of view.

8. An apparatus for visualizing air flow around a vehicle, comprising:
one or more gas emitters supportable by a vehicle, each configured to emit a gas that can flow over one or more surfaces of the vehicle as ambient air passes over the vehicle;
one or more imaging devices each having a field of view of at least a portion of the gas flowing over the vehicle;
an ultrasound or radar signal source for transmitting a signal to at least a portion of the field of view of each or all of the one or more imaging devices;
a signal processor configured to generate an image based on an input from the imager;
wherein:
the gas is not detectable to the naked eye so as to not obstruct a vehicle operator's field of vision;
the ultrasound or radar signal source is configured to emit a signal at a wavelength that will be reflected by the gas; and
the apparatus is configured to produce an image of the flow of the gas over the one or more surfaces of the vehicle when in an operational state.

9. The apparatus of claim 8, comprising an ultrasound signal source.

10. The apparatus of claim 8, comprising a radar signal source.

11. A method of visualizing air flow around a vehicle, comprising:
emitting a gas from one or more gas emitters into a flow of air moving past a vehicle, the gas being invisible to the naked eye;
irradiating a field of view of one or more imaging devices with a light source at a wavelength that will be absorbed by the gas, the field of view being directed to at least a portion of the gas flowing over the vehicle;
gathering an image of the field of view with the one or more imaging devices; and
generating an image on a video screen of the flow of gas around the vehicle based on a signal output from the imager.

12. The method of claim 11, further comprising recording the image of the flow of gas around the vehicle.

13. The method of claim 11, further comprising adjusting an orientation of one or more of the imaging devices to change the field of view of the one or more imaging devices.

14. The method of claim 11, further comprising remotely adjusting an orientation of one or more of the imaging devices to change the field of view of the one or more imaging devices.

15. The method of claim 11, further comprising changing a configuration of one or more exterior surfaces of the vehicle based on one or more images gathered by the imaging devices.

16. The method of claim 11, further comprising irradiating a field of view of one or more imaging devices with a laser light source.

17. The method of claim 11, wherein generating an image on a video screen of the flow of gas around the vehicle based on a signal output from the imager comprises wirelessly transmitting the image to a remote video screen not supported by the vehicle.

18. The method of claim 11, wherein the gas emitters are positioned on the vehicle.
